(19) United States
(12) Patent Application Publication
(10) Pub. No.: US 2015/0090192 A1
(43) Pub. Date: Apr. 2, 2015

(54) Animal Chew

(71) Applicant: FOSTER AND SMITH, INC., RHINELANDER, WI (US)

(72) Inventors: JOHN B. POWERS, RHINELANDER, WI (US); KATHARINE HILLESTAD, RHINELANDER, WI (US); MATHEW J. OSENGA, RHINELANDER, WI (US)

(73) Assignee: FOSTER AND SMITH, INC., RHINELANDER, WI (US)

(21) Appl. No.: 14/044,164

(22) Filed: Oct. 2, 2013

(51) Int. Cl. A01K 11/00

(52) U.S. Cl. CPC A01K 15/026
USPC 119/709

(57) ABSTRACT

Embodiments of an animal chew are provided as having a first club end and a second club end coupled by a narrowed neck. The club ends are at least substantially cylindrical in shape, each including a plurality of nubs protruding radially outward therefrom. Animal chews according to the present invention are formed from a combination of materials and include a healthy blend of protein, fat, fiber, and fatty acids.

### BACKGROUND OF THE INVENTION

The present invention relates generally to devices that may be provided to animals to chew on, and more specifically to an edible animal chew with advantageous nutritional properties, formability, shape, and texture.

Animals love to chew. Not only does it appear that animals receive enjoyment from chewing on various objects, if the proper object is provided, the chewing experience can be beneficial to the animal. For instance, chewing on a properly formed object may provide beneficial cleaning of the animal mouth, including tongue, teeth and gingiva. Furthermore, if the proper object provided is intended to be edible, the experience may provide nutritional supplementation for the animal.

Prior animal chews, edible and inedible, have been formed from a variety of materials, including rawhide, gelatinized starch, nylon, wood, polyurethane, thermoplastic, rubber, and/or various natural ingredients.

Prior animal chews have also been formed in a variety of shapes. Many prior chew shapes are formed to resemble ex vivo animal bones or caricatures thereof, or even simple cylinders or spheres.

While many prior animal chews have been developed, the art of personal animal care is still in need of an improved animal chew that provides a balance of fatty acids, but yet is easily formable and provides a desired texture and shape, which is suitable to gently abrade the tongue, teeth, and/or gingiva of the animal to improve oral health thereof.

### SUMMARY OF THE INVENTION

An animal chew according to the present invention may be generally dumbbell-shaped, including a shaft extending along a longitudinal length and surrounding a longitudinal chew axis from a first chew end to a second chew end. The shaft preferably includes a first club portion extending from the first chew end towards the second chew end. The first club portion has an outer surface disposed about a first club diameter measured perpendicular to the longitudinal length. The shaft also preferably has a second club portion extending from the second chew end towards the first chew end. The second club portion has an outer surface disposed about a second club diameter measured perpendicular to the longitudinal length. The first club portion and the second club portion are preferably joined by a neck portion. The neck portion has a neck diameter measured perpendicular to the longitudinal length, wherein the neck diameter is smaller than the first club diameter and the neck diameter is smaller than the second club diameter.

According to an aspect of an embodiment of an animal chew according to the present invention, the shaft is solid.

According to another aspect of an embodiment of an animal chew according to the present invention, the first and/or second club portions may comprise a substantially cylindrical outer surface. A plurality of nubs may be provided, protruding from the substantially cylindrical surface. Some of the nubs may be arranged in one or more radial rows encircling the chew axis of the shaft. Some of the nubs may be arranged in one or more longitudinal rows extending parallel to the chew axis. Some of the nubs may be arranged in one or more helical spirals about the chew axis.

According to yet another aspect of an embodiment of an animal chew according to the present invention, the longitudinal length of the shaft may be related to other dimensions of the chew. For instance, for a given longitudinal length X, the first club diameter may be in the range of 0.15X to 0.23X. The second club diameter may be in the range of 0.15X to 0.23X. The first club diameter and the second club diameter may be substantially equal. The neck diameter may vary between the first club portion and the second club portion between a thin neck portion in the range of 0.10X to 0.12X and a thick neck portion in the range of 0.13X to 0.15X.

According to still another aspect of an embodiment of an animal chew according to the present invention, the chew may include ingredients such as a protein component, a fat component, a fiber component, and a fatty acid component. The protein component may form at least thirty-five percent by weight of the chew. The fat component may form 3.5 to five percent by weight of the chew. The fiber component may form a maximum of three percent by weight of the chew. The fatty acid component may form at least 0.62 percent by weight of the chew. A preferred fatty acid component is a combination of n-3 and n-6 fatty acids, wherein the ratio of n-6 to n-3 fatty acids is about 8:1, or more preferably 55:7.

### BRIEF DESCRIPTION OF THE DRAWINGS

FIG. 1 is a perspective view of an embodiment of an animal chew according to the present invention.

FIG. 2 is a front elevation view of the animal chew of FIG. 1.

FIGS. 3A and 3B depict a first embodiment of a cleaning nub arrangement according to the present invention.

FIGS. 4A and 4B depict a second embodiment of a cleaning nub arrangement according to the present invention.

FIGS. 5A and 5B depict a third embodiment of a cleaning nub arrangement according to the present invention.

FIG. 6A is a cross-sectional view taken along line 6A-6A of FIG. 2.

FIG. 6B is a cross-sectional view taken along line 6B-6B of FIG. 2.

FIG. 7 is a cross-sectional view taken along line 7-7 of FIG. 2.

FIG. 8 is a cross-sectional view taken along line 8-8 of FIG. 2.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

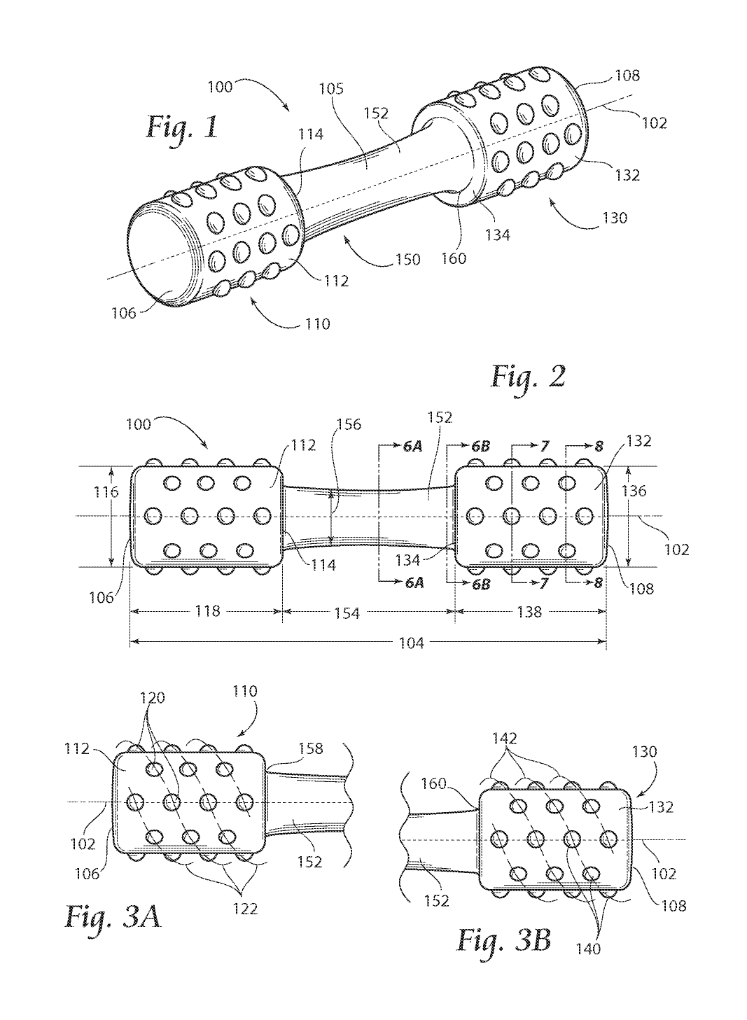

Turning now to the figures, FIG. 1 and FIG. 2 present a first embodiment 100 of an animal chew according to the present invention. Formed about a chew axis 102, along a longitudinal length 104, is a shaft 105 extending from a first end 106 to a second end 108. The shaft 105 generally includes a first club-shaped portion 110, a second club-shaped portion 130, and a neck portion 150. The first club portion 110 extends from the first chew end 106 towards the second chew end 108. The first club portion 110 includes a generally cylindrical outer surface 112 extending from the first chew end 106 to a first club end 114. The outer surface 112 is formed about a first club diameter 116 measured perpendicular to the chew axis 102 and along a first club length 118 measured parallel to the chew axis 102. While other configurations are possible, the first club portion 110 is preferably of solid construction throughout its diameter 116 and its length 118. Disposed on the outer surface 112 is a plurality of radially extending nubs 120, which are preferably dome-shaped. As will be described in further detail below, the nubs 120 may be arranged in a variety of one or more configurations, such as radial rows, longitudinal rows, helical spirals, or in a predetermined, pseudo-random pattern.

The second club portion 130 extends from the second chew end 108 towards the first chew end 106. The second club portion 130 includes a generally cylindrical outer surface 132 extending from the second chew end 108 to a second club end 134. The outer surface 132 is formed about a second club diameter 136 measured perpendicular to the chew axis 102 and along a second club length 138 measured parallel to the chew axis 102. While other configurations are possible, the second club portion 130 is preferably of solid construction throughout its diameter 136 and its length 138. Disposed on the outer surface 132 is a plurality of radially extending nubs 140, which are preferably dome-shaped. As will be described in further detail below, the nubs 140 may be arranged in a variety of one or more configurations, such as radial rows, longitudinal rows, helical spirals, or in a predetermined, pseudo-random pattern.

The neck portion 150 couples the first club portion 110 to the second club portion 130. The neck portion 150 preferably includes a neck shaft 152 spanning a neck length 154 between the first club end 114 and the second club end 134. The neck shaft 152 has a diameter 156 measured perpendicular to the chew axis 102. While the neck shaft 152 may be formed with a uniform diameter 156 along its length 154, the diameter 156 is preferably not uniform, and even more preferably, the diameter 156 varies continuously along at least a portion of the shaft length 154. For instance, the neck shaft 152 meets the first club end 114 at a first club juncture 158 and meets the second club end 134 at a second club juncture 160. While the diameter 156 of the neck shaft 152 is preferably substantially equal at the first club juncture 158 and the second club juncture 160, the shaft 152 preferably has a smaller diameter between the junctures 158,160, and may have a minimum diameter 156′ (FIG. 6A) at a location along the chew axis 102 that is preferably substantially midway between the junctures 158,160, and more preferably at a location along the chew axis 102 that is substantially equidistant from the first chew end 106 and the second chew end 108. In one embodiment, the diameter 156 of the neck shaft 152 varies continuously along the entire length 154 of the shaft 152, between the first club juncture 158 and the second club juncture 160.

As indicated above, nubs may be placed or formed on the outer surface of the club portions in a variety of beneficial configurations. A first arrangement of nubs 120 on the first club portion 110 is shown in FIG. 3A. As can be seen, a plurality of the nubs 120 may be arranged in one or more helical spiral patterns 122 about the chew axis 102.

A first arrangement of nubs 140 on the second club portion 130 is shown in FIG. 3B. As can be seen, a plurality of the nubs 140 may be arranged in one or more helical spiral patterns 142 about the chew axis 102.

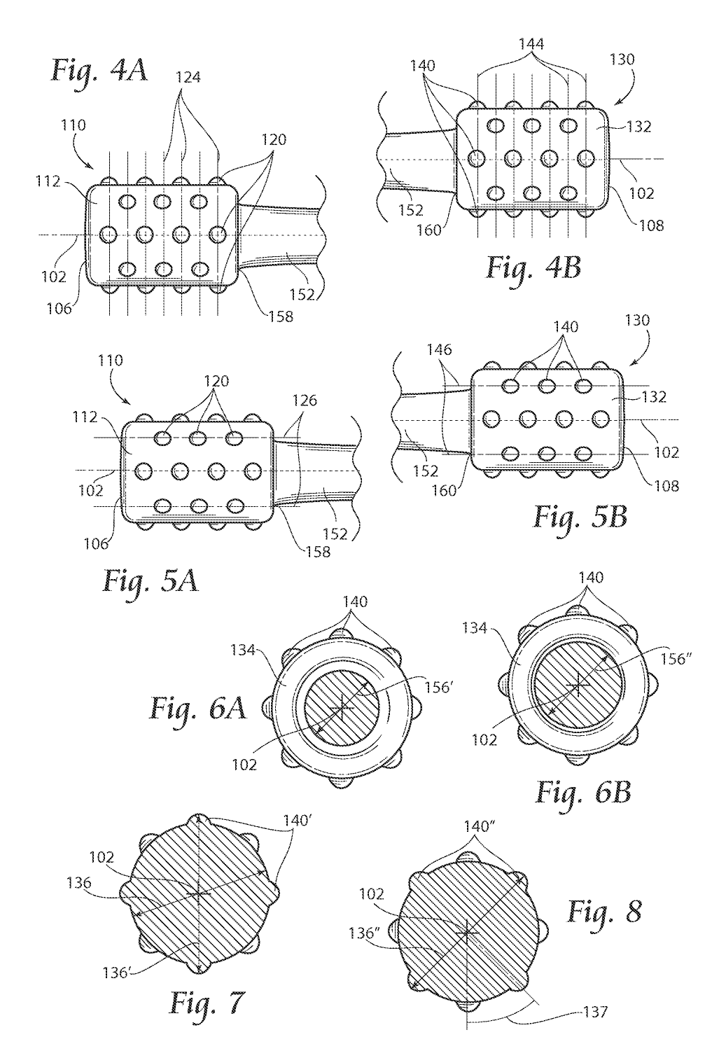

A second arrangement of nubs 120 on the first club portion 110 is shown in FIG. 4A. As can be seen, a plurality of the nubs 120 may be arranged in one or more radial rows 124 surrounding the chew axis 102.

A second arrangement of nubs 140 on the second club portion 130 is shown in FIG. 4B. As can be seen, a plurality of the nubs 140 may be arranged in one or more radial rows 144 surrounding the chew axis 102.

A third arrangement of nubs 120 on the first club portion 110 is shown in FIG. 5A. As can be seen, a plurality of the nubs 120 may be arranged in one or more longitudinal rows 126 parallel to the chew axis 102.

A third arrangement of nubs 140 on the second club portion 130 is shown in FIG. 5B. As can be seen, a plurality of the nubs 140 may be arranged in one or more longitudinal rows 146 parallel to the chew axis 102.

It is to be understood that one or more of the nub arrangements 122/142, 124/144, and/or 126/146 may be combined on each club portion and between club portions on the same chew. For instance, a plurality of nubs 120 may be arranged in one or more helical spirals 122 on the first club portion 110 of a first chew and a plurality of nubs 140 may be arranged in one or more helical spirals 142, radial rows 144, and/or longitudinal rows 146 on the second club portion 130 of the same first chew. Additionally or alternatively, a plurality of nubs 120 may be arranged in one or more radial rows 124 on the first club portion 110 of a second chew and a plurality of nubs 140 may be arranged in one or more helical spirals 142, radial rows 144, and/or longitudinal rows 146 on the second club portion 130 of the same second chew. Additionally or alternatively, a plurality of nubs 120 may be arranged in one or more longitudinal rows 126 on the first club portion 110 of a third chew and a plurality of nubs 140 may be arranged in one or more helical spirals 142, radial rows 144, and/or longitudinal rows 146 on the second club portion 130 of the same third chew.

While animal chews according to the present invention may be provided in a variety of sizes, certain size relationships or aspect ratios are preferably maintained no matter what size chew is provided. Animal chews according to the present invention may be provided in, e.g., small, medium, and/or large sizes. A small animal chew according to the present invention may have a mass of between eight and fourteen grams, with a mass of about 10 grams (10.2 grams) preferred. A medium animal chew according to the present invention may have a mass of between fifteen and thirty grams, with a mass of about 20 grams (19.7 grams) preferred. A large animal chew according to the present invention may have a mass of between thirty and fifty grams, with a mass of about 40 grams (41.7 grams) preferred. Regarding dimensions, if a chew 100 is provided with a length 104 of X, then the length of the first club portion 110, second club portion 130 and neck portion 150 may be related thereto. For instance, it has been found that favorable performance of the chew 100 may be effected where each length 118,138,154 is about X/3. Furthermore, each diameter 116,136,156 may be related to the length 104 of X. The diameter 116 of the first club portion 110 is preferably in the range of 0.15X to 0.23X, with about 0.18X being most preferred. The diameter 136 of the second club portion 130 is in the range of 0.15X to 0.23X, with about 0.18X being most preferred. The neck diameter 156 may be consistent throughout its length 154, but preferably varies between the first club portion 110 and the second club portion 130. Preferably, as described above, and with reference to FIGS. 6A and 6B, the thinnest diameter 156′ of the neck 150 is preferably at a point that is at least approximately equidistant from the first chew end 106 and the second chew end 108, the thinnest diameter 156′ preferably being in the range of 0.10X to 0.12X. The neck 150 has its thickest diameter 156″ closer to the first club juncture 158 and second club juncture 160. This thickest diameter 156″, again with reference to a chew length 104 of X, is preferably in the range of 0.13X to 0.15X.

With reference to FIGS. 7 and 8, two different, longitudinally displaced cross-section views of the second club portion 130 of the embodiment 100 of an animal chew according to the present invention are shown. The diameter 136 of the second club portion 130, as previously described, can be seen in FIG. 7. Also, a nub diameter 136′ is provided, which is measured perpendicular to the chew axis 102, and to the radially outermost part of at least one nub 140′. Alternatively, as shown, the nub diameter 136′ may be measured perpendicular to the chew axis, between and including the radially outermost part of two nubs 140′. The nub diameter 136′ is preferably eight to twenty percent larger than the club diameter 136. More particularly, if measured through one nub 140′, the nub diameter 136′ is preferably eight to twelve percent larger than the club diameter 136, and, if measured through two, diametrically opposed nubs 140′, the nub diameter 136′ is preferably sixteen to twenty percent larger than the club diameter 136. As shown, a plurality of nubs 140′, some of which may be diametrically opposed, is arranged in a first radial row about the chew axis 102.

Turning to FIG. 8, there may be a second nub diameter 136″, which is measured perpendicular to the chew axis 102. The second nub diameter 136″ is longitudinally displaced along the chew axis 102 from the first nub diameter 136′, previously described. The second nub diameter 136″ is also measured between and including a plurality of nubs 140″, which are arranged in a second radial row about the chew axis 102. As shown, however, the nubs 140″ of the second radial row are rotated by an angle 137 about the chew axis with respect to the first radial row of nubs 140′ previously discussed. A preferred angle 137 is forty-five degrees.

Preferred materials for the formation of an animal chew according to the present invention include protein components, fat components, fiber components, and fatty acid components. An animal chew according to the present invention preferably includes at least thirty-five percent by weight crude protein, at least three and one-half percent by weight but no more than five percent by weight crude fat, a maximum of three percent by weight crude fiber, and a minimum of 0.62 percent by weight fatty acid blend. The fatty acid blend is preferably a blend of polyunsaturated fatty acids, such as n-3 and n-6 fatty acids. A preferred mixture of n-3 (omega-3) and n-6 (omega-6) fatty acids is nearly eight times the amount of n-3 fatty acids, by weight, of n-6 fatty acids. For example, a preferred fatty acid blend is 0.55 percent by weight n-6 fatty acids and 0.07 percent by weight of n-3 fatty acids.

To achieve the above preferred component blend, ingredients for animal chews according to the present invention are wheat gluten, glycerin, tapioca starch, gelatin, pineapple stems, natural chicken liver flavor, powdered cellulose, palm oil, sodium copper chlorophyllin, beta carotene, flaxseed, fructooligosaccharide, alpha-tocopherol acetate, sodium propionate (as a preservative), and sugar. While other fatty acid sources may be utilized, the palm oil is preferably a source of the n-6 fatty acids and the flaxseed is a source of the n-3 fatty acids. Other sources of n-6 fatty acids include fruits, nuts, and other oils. Fruits such as avocados are good sources of n-6 fatty acids. Nuts such as cashews, pecans, walnuts, and coconuts are also acceptable sources.

Other oils may include one or more of hemp oil, soybean oil, cottonseed oil, sunflower seed oil, corn oil, and safflower oil. Other sources of n-3 fatty acids include fish, fish oils, or krill oil, fruits such as kiwifruit and black raspberries, and other oils, such as hemp oil, linseed oil, and canola oil. While various dyes or colors could be added to embodiments of an animal chew according to the present invention, such artificial coloring is preferably avoided.

The materials are preferably combined in such a way to provide a desired density, such as about 1.25 to about 1.40 grams per cubic centimeter, with a preferred density of about 1.30 (1.29 to 1.31) grams per cubic centimeter. One process that may be used to form an animal chew according to the present invention includes combining dry ingredients and creating a grainy textured mixture by adding some fat and glycerin. The mixture may be extruded, cooled and granularized prior to an injection molding process. Once molded, the chews may be trimmed, inspected/graded, and packaged for shipment or sale.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. An animal chew comprising:
a shaft extending along a longitudinal length and surrounding a longitudinal chew axis from a first chew end to a second chew end, wherein the shaft comprises,
a first club portion extending from the first chew end towards the second chew end, the first club portion having an outer surface disposed about a first club diameter measured perpendicular to the longitudinal length;
a second club portion extending from the second chew end towards the first chew end, the second club portion having an outer surface disposed about a second club diameter measured perpendicular to the longitudinal length; and,
a neck portion joining the first club portion and the second club portion, the neck portion having a neck diameter measured perpendicular to the longitudinal length, wherein the neck diameter is smaller than the first club diameter and the neck diameter is smaller than the second club diameter.

2. An animal chew according to claim 1, wherein the shaft is solid.

3. An animal chew according to claim 1, wherein the first club portion comprises a substantially cylindrical outer surface.

4. An animal chew according to claim 3, further comprising a plurality of nubs protruding from the substantially cylindrical outer surface of the first club portion.

5. An animal chew according to claim 4, wherein a first plurality of the nubs is arranged in a radial row encircling the chew axis.

6. An animal chew according to claim 5, wherein a second plurality of the nubs is arranged in a longitudinal row parallel to the chew axis.

7. An animal chew according to claim 6, wherein a third plurality of the nubs is arranged in a helical spiral about the chew axis.

8. An animal chew according to claim 4, wherein a first plurality of the nubs is arranged in a longitudinal row parallel to the chew axis.

9. An animal chew according to claim 8, wherein a second plurality of the nubs is arranged in a helical spiral about the chew axis.

10. An animal chew according to claim 4, wherein a plurality of the nubs is arranged in a helical spiral about the chew axis.

11. An animal chew according to claim 4, wherein each nub is a member of a first plurality of nubs arranged in a radial row encircling the chew axis, is a member of a second plurality of nubs arranged in a longitudinal row parallel to the chew axis, and is a member of a third plurality of nubs arranged in a helical spiral about the chew axis.

12. An animal chew according to claim 1, wherein the longitudinal length is X, the first club diameter is in the range of 0.15X to 0.23X, the second club diameter is in the range of 0.15X to 0.23X, and the neck diameter varies between the first club portion and the second club portion between a thin neck portion in the range of 0.10X to 0.12X and a thick neck portion in the range of 0.13X to 0.15X.

13. An animal chew comprising:
a protein component;
a fat component;
a fiber component; and
a fatty acid component.

14. An animal chew according to claim 13, comprising at least thirty-five percent by weight of the protein component.

15. An animal chew according to claim 13, comprising 3.5 percent to five percent by weight of the fat component.

16. An animal chew according to claim 13, comprising a maximum of three percent by weight of the fiber component.

17. An animal chew according to claim 13, comprising at least 0.62 percent by weight of the fatty acid component.

18. An animal chew according to claim 13, wherein the fatty acid component comprises n-3 and n-6 fatty acids.

19. An animal chew according to claim 18, wherein the ratio of n-6 to n-3 fatty acids is about 8:1.

20. An animal chew according to claim 19, wherein the ratio of n-6 to n-3 fatty acids is 55:7.
